(19) United States
(12) Patent Application Publication
(10) Pub. No.: US 2017/0054218 A1
(43) Pub. Date: Feb. 23, 2017

(54) Antenna Arrangement

(71) Applicant: Nokia Solutions and Networks Oy, Espoo (FI)

(72) Inventors: Mikko Juhani JUNTTILA, Oulu (FI); Eero Olavi HEIKKINEN, Oulu (FI)

(21) Appl. No.: 15/307,871

(22) PCT Filed: May 9, 2014
(86) PCT No.: PCT/EP2014/059572

§ 371 Date: Oct. 31, 2016

(51) Int. Cl. H01Q 13/08; H01Q 1/48; H01Q 1/24; H01Q 15/14

(52) U.S. Cl. CPC H01Q 13/085; H01Q 15/14; H01Q 1/48; H01Q 1/246

(57) ABSTRACT

A Vivaldi antenna is disclosed, including an antenna upper part, and an antenna throat, wherein the antenna upper part is tilted, in respect to the antenna throat, at a predetermined location of the antenna upper part. The antenna upper part may be tilted, in respect to the antenna throat, by one or more predetermined tilted angles respectively at one or more predetermined locations of the antenna upper part. A corresponding antenna pair, antenna array and base station are also disclosed.

### FIELD OF THE INVENTION

The exemplary and non-limiting embodiments of this invention relate generally to cellular radio systems, and more particularly to an antenna arrangement.

### BACKGROUND ART

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Existing base station antenna systems typically use patch or dipole type of antennas with or without a reflector. Existing antenna types do not necessarily cover enough bandwidth for multiple cellular bands. For example, it may be difficult to find an antenna design covering a bandwidth of 1.71 GHz-2.69 GHz. Even if such an antenna design is found, its radiation properties may vary too much in terms of frequency. While trying to cover the bandwidth of 1.71 GHz-2.69 GHz, it may be difficult to find an antenna design which also fulfils specified matching, isolation and cross-polarization isolation requirements.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the invention comprise an antenna, an antenna pair and an antenna array as defined in the independent claims. Further embodiments of the invention are disclosed in the dependent claims.

An aspect of the invention relates to a Vivaldi antenna comprising an antenna upper part, and an antenna throat, wherein the antenna upper part is tilted, in respect to the antenna throat, at a predetermined location of the antenna upper part.

A further aspect of the invention relates to a Vivaldi antenna pair comprising two or more of said Vivaldi antennas.

A still further aspect of the invention relates to a Vivaldi antenna array comprising two or more of said antenna pairs.

A still further aspect of the invention relates to a base station comprising at least one of said antenna, antenna pair and antenna array.

A still further aspect of the invention relates to a computer program product comprising executable code that when executed, causes execution of functions of the method.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments with reference to the attached drawings, in which

FIGS. 1 and 2 illustrate a Vivaldi antenna shape;

FIGS. 3, 4 and 5 illustrate Vivaldi antenna structures according to an exemplary embodiment;

FIG. 6 illustrates Vivaldi antenna spacing according to an exemplary embodiment;

FIGS. 7a and 7b illustrate balancing of Vivaldi antenna half power beam width according to an exemplary embodiment;

FIGS. 8, 9 and 10 illustrate Vivaldi antenna feed network locations according to an exemplary embodiment;

FIG. 11 illustrates Vivaldi antenna ground planes according to an exemplary embodiment;

FIG. 12 illustrates a Vivaldi antenna T-junction according to an exemplary embodiment;

FIG. 13 illustrates Vivaldi antenna reflectors isolated in an antenna array according to an exemplary embodiment;

FIG. 14 illustrates a Vivaldi antenna common ground plane according to an exemplary embodiment;

FIG. 15 illustrates a Vivaldi antenna feed arrangement by using a microstrip according to an exemplary element.

### DETAILED DESCRIPTION OF SOME EMBODIMENTS

A Vivaldi antenna is a kind of a two-dimensional projection of a three-dimensional horn antenna with an additional circular throat. The Vivaldi antenna may be made of printed wire board (PWB), metal, coated plastics or other suitable materials. The Vivaldi antenna is typically fed by a galvanic contact or it may be capacitively coupled. The Vivaldi antennas may be made for linear polarized waves or for transmitting/receiving two polarization orientations. The Vivaldi antennas are scalable in size for use at any frequency. The broadband characteristics of the Vivaldi antennas make them suitable for ultra wideband signals. The Vivaldi antennas may be used as reference antennas and in other special applications.

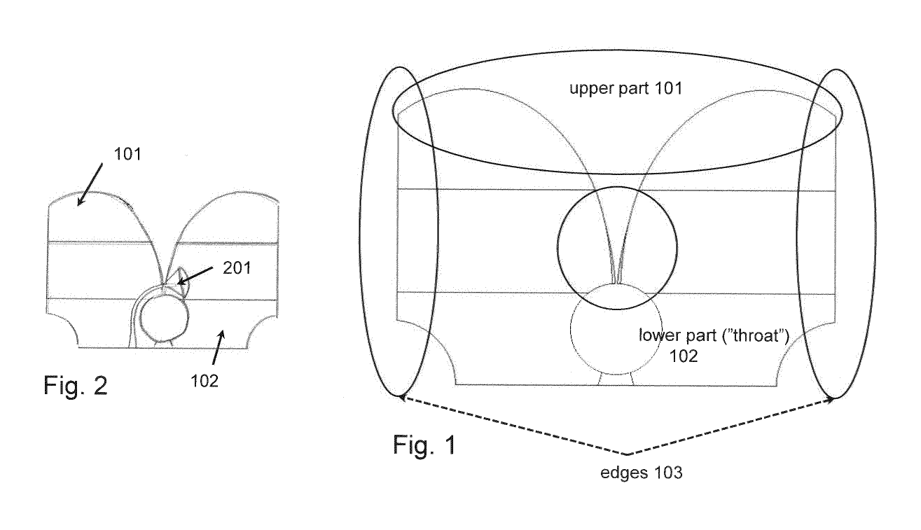

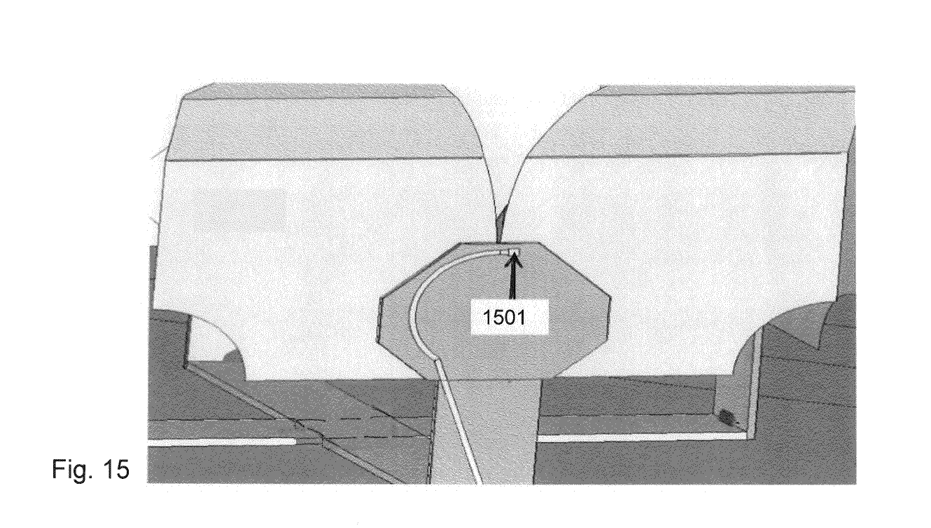

The Vivaldi antenna is a travelling wave type of antenna which has a relatively wide radiation bandwidth compared to resonant type of antennas (such as dipole antennas). Higher frequencies are formed in a lower part 102 of an antenna element (the lower part of the antenna element may also be referred as an antenna element throat or just “throat”). Correspondingly, lower frequencies are formed in an upper part 101 of the antenna element and in the edges (see FIG. 1). The antenna 103 may be fed capacitively through a coupling element (see FIG. 2) 201, or direct cable feeding may be used. Also a feed arrangement 1501 illustrated in FIG. 15 (microstrip) may be used, wherein FIG. 15 illustrates an exemplary dual polarized Vivaldi pair implemented with a galvanic feeding 1501.

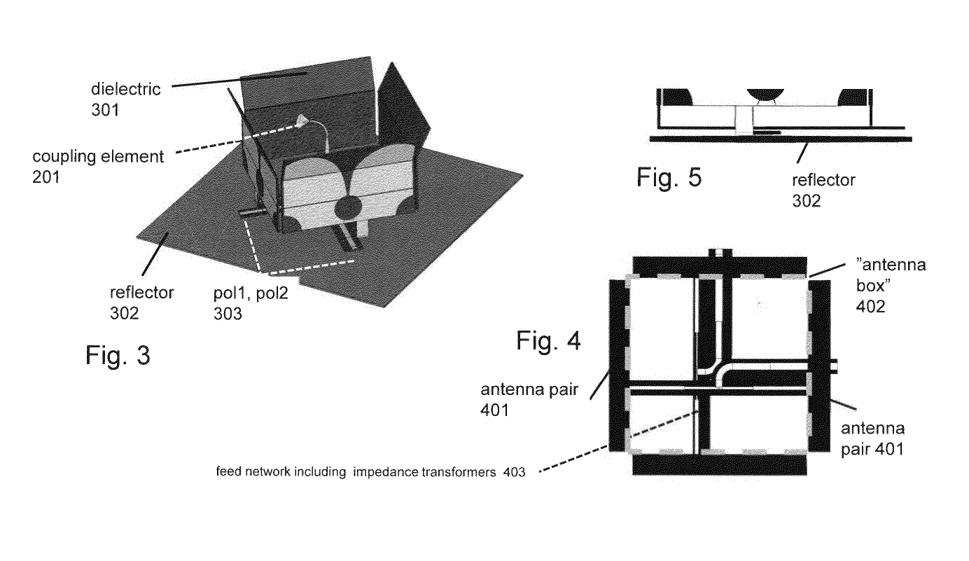

FIGS. 3, 4 and 5 illustrate an exemplary Vivaldi antenna structure. The antenna has two ±45 degree polarizations (slant). The Vivaldi antenna elements are fed capacitively by using the coupling element 201. The antenna has a reflector 302 for improving antenna directivity. One polarization (antenna pair 401) contains two Vivaldi antenna elements 103 which are combined to a single feed point by using a feed network 403 including impedance transformers. The feed network 403 is placed inside an “antenna box” 402 for decreasing the total size of the antenna 103. The polarizations 303 are isolated from each other for improving isolation between the polarizations (see FIG. 5). Both of the polarizations are isolated from the reflector 302 for improving electrical characteristics of the antenna 103 (exemplary radiation properties and S-parameters on a wide frequency range). The feed network 403, the antenna elements 103, and the coupling element 301 are placed on a dielectric 301. The electrical characteristics (the S-parameters and the radiation properties) may be adjusted by changing dielectric material or dielectric thicknesses on various locations of the antenna structure, or by using pure air. The structure may be also be “hybrid”, wherein two or more different dielectric materials are used.

When the antennas 103 are used as a pair, horizontal plane half power beam width (HPBW) may be controlled by antenna spacing, such that a longer spacing enables at least one of more antenna directivity, more antenna gain and a narrower horizontal plane HPBW. Also radiation properties may be adjusted by adjusting a distance to reflector (DTR) of the antenna.

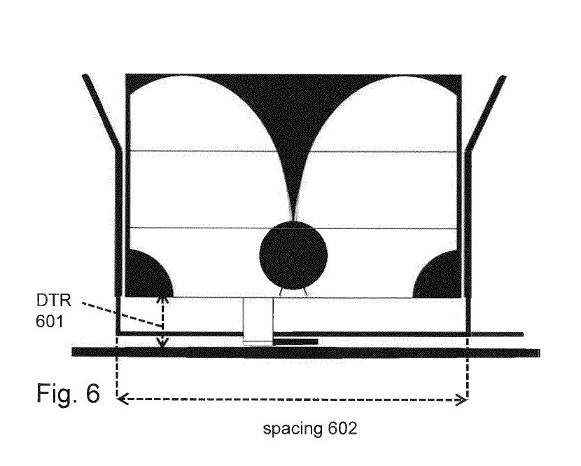

When DTR 601 of the Vivaldi element 103 is reduced (closer to the reflector), the antenna directivity increases. Correspondingly, horizontal plane HPBWs get narrower. The same phenomenon occurs when the antenna spacing 602 (see FIG. 6) is adjusted.

When DTR 601 is reduced, the horizontal plane HPBWs are more unbalanced between lower and higher frequencies. This is because (as presented above in connection with FIG. 1) the lower frequencies are formed in the upper part 101 of the Vivaldi element 103 and the higher frequencies in the lower part 102. Therefore, the lower and higher frequencies have different DTRs in relation to wave length, and due to this reason the horizontal plane HPBWs vary as a function of frequency. Thus, the lower frequencies have less directivity and wider horizontal plane HPBWs compared to the higher frequencies.

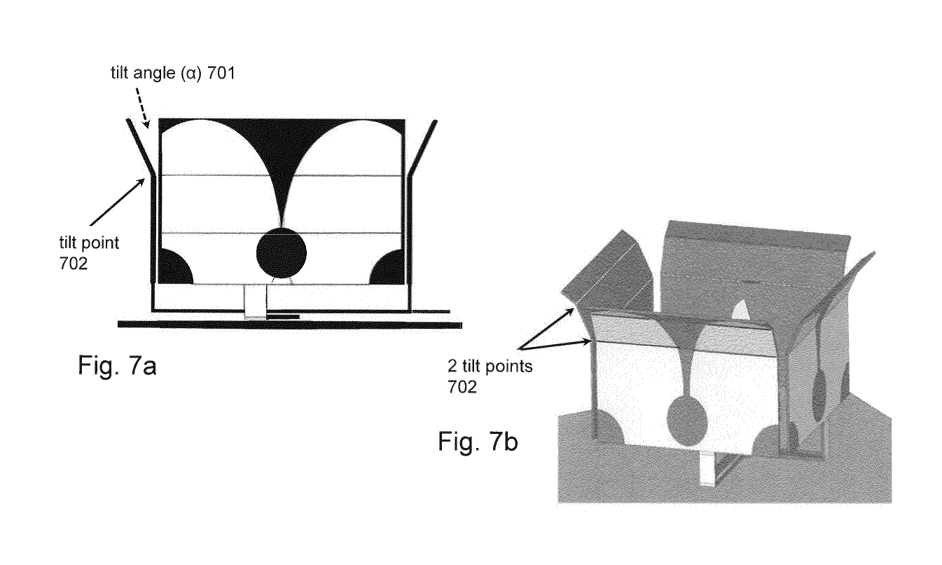

According to an exemplary embodiment, when a tilt angle 701 is adjusted in the upper part 101 of the antenna 103, the antenna spacing 602 is changed (see FIGS. 7a and 7b) (also the distance to reflector of the antenna is changed since the tilted part becomes closer to the reflector 302 due to the antenna element tilt).

According to an exemplary embodiment, the lower frequency horizontal plane HPBWs may be selectively adjusted. The horizontal plane HPBWs may be balanced and/or unbalanced across antenna operating frequency.

There may be one or more locations, i.e. tilt points 702 (creases, folds, groins, specific sites where there is a change of declivity/change of gradient/change of inclination of the antenna upper part 101; for example, the tilt point may be a linear fold across the antenna upper part 101) at which the antenna upper part 101 is tilted. The antenna 103 may be tilted inwards and/or outwards.

In an exemplary embodiment, the tilting of the antenna 103 is not a requirement; instead the antenna spacing 602 may be adjusted e.g. by making an antenna of a different shape (a slope shaped antenna etc.) to enable modified frequency tuning, radiation characteristics, antenna impedance matching and/or isolation.

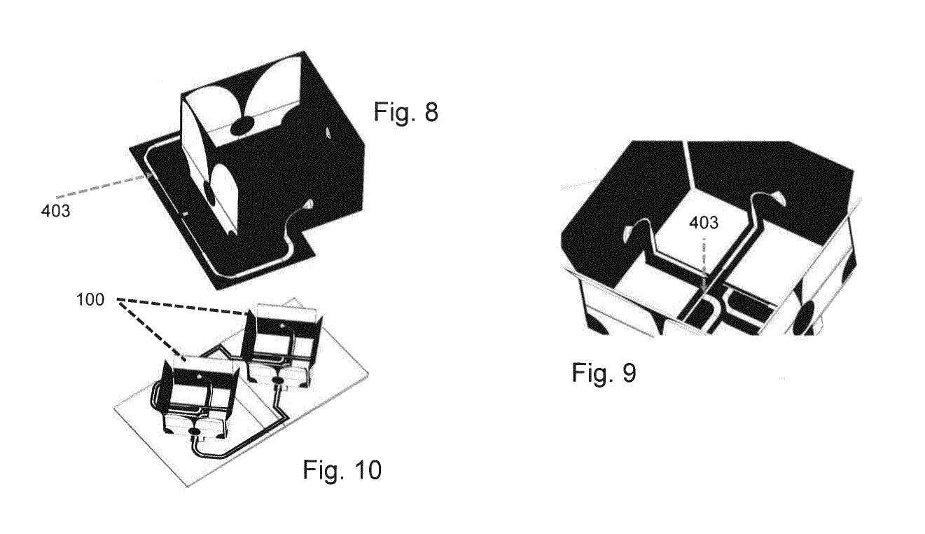

According to an exemplary embodiment, the feed network (i.e. combiner network) 403 may also be located on the antenna side of the reflector 302. This decreases the total height of the antenna 103. The feed network 403 may be located inside the antenna box 402 (see FIGS. 4 and 9) or outside the antenna box 402 (see FIG. 8).

An antenna array 100 may be obtained by combining the polarization (or polarizations) of two or more antennas 103, by combining the polarization of an antenna pair (FIGS. 8 and 9), or by combining the polarizations of antenna pairs 401 (an example of two polarizations is illustrated in FIG. 10). In the above examples, a single element may be replaced with multiple individual elements lined next to each other for which the polarization is connected (for example, four elements instead of two elements may be used to form the antenna pair). Polarization connecting may be done by using the feed network 403 at the antenna side of the reflector 302 (see FIG. 10). The feed network may also be located on antenna opposite side of the reflector e.g. for further improving antenna radiation characteristics (beam shape).

Vertical plane HPBWs may be adjusted by adjusting a spacing between the antennas 103/antenna pairs 401 in the antenna array 100.

According to an exemplary embodiment, an impedance matching network may be implemented in the feed network 403. The impedance matching network may be located inside the antenna box 402 (see FIGS. 4 and 9) or outside the antenna box (see FIG. 8). Discrete components may be used for impedance matching as well. The impedance matching network may also be located on the antenna opposite side of the reflector.

Microstrips may require a ground plane 111 for impedance control. According to an exemplary embodiment, ground planes 111 are used as impedance matching elements in the antenna structure.

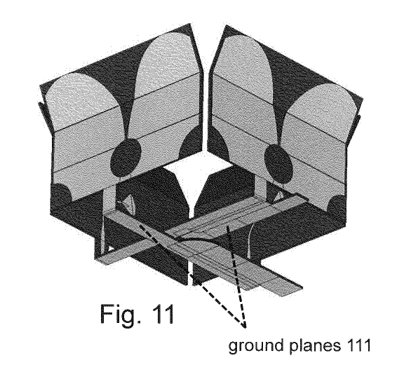

According to an exemplary embodiment, the ground planes (see FIG. 11) 111 inside the antenna box 402 or outside the antenna box 402 act as additional reflector(s). Therefore, the radiation characteristics (antenna directivity, antenna gain, horizontal plane HPBW, vertical plane HPBW) of the antenna 103 may be adjusted with these types of ground planes 111. These ground planes may also be “floating” (not grounded).

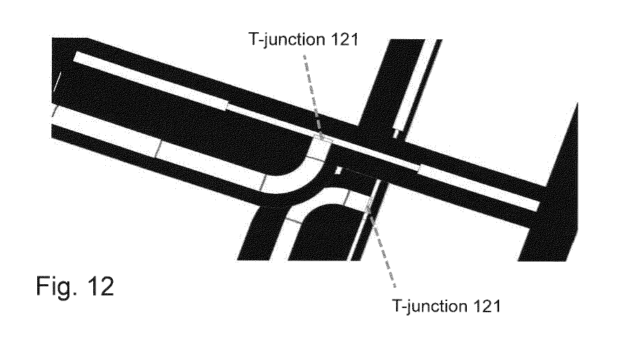

According to an exemplary embodiment, the radiation characteristics of the antenna pair 401 may be adjusted by adjusting the position of a T-junction 121 (T-junction point on the feed network 403, see FIG. 12).

According to an exemplary embodiment, the radiation properties of the antenna pair 401 may be adjusted by modifying the shape of the reflector 302 and/or by adding additional parts to the reflector.

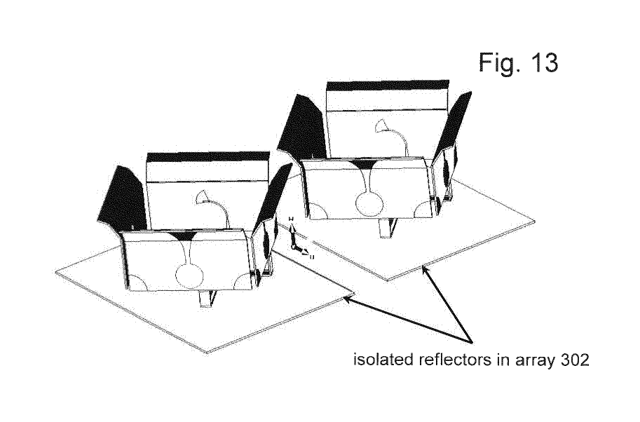

FIG. 13 illustrates reflectors 302 isolated in an antenna array 100. According to an exemplary embodiment, the use of the antenna array 100 enables improving isolation between the polarizations 303 in the antenna array 100, improving the impedance matching of the antenna array 100, and controlling the radiation properties of the antenna array 100.

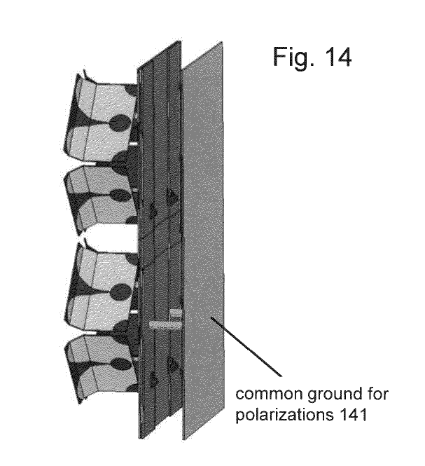

According to an exemplary embodiment, the polarization ground planes 111 are combined at some point (see FIG. 14). Therefore a common ground plane 141 is added on the opposite side of the reflector 302 (opposite to the antenna side of the reflector 302). The isolation between the polarizations 303 is increased, while a gap between an antenna common ground 141 and the reflector 302 is increased.

An exemplary embodiment discloses a way to use the Vivaldi antenna design in a commercial cellular system antenna structure. The Vivaldi antenna design according to an exemplary embodiment uses a pair of Vivaldi antenna elements in a symmetrical fashion.

An exemplary embodiment discloses controlling the radiated beam width and beam shape over a very wide band. Regarding the Vivaldi antenna design used, there are independent parameters for controlling beam width and beam shape: a) an individual Vivaldi antenna tilt, b) an individual Vivaldi antenna radiator shape (e.g. making it higher), c) the distance to reflector, d) the antenna pair spacing, e) phasing of the combining point of the antenna pair may be used to shape the beam width and radiation direction, f) shaping a reflector blade and/or adding additional parts to the reflector may also be used to shape a radiation pattern.

An exemplary embodiment discloses performing the impedance matching for a very wide band antenna pair. Regarding the Vivaldi antenna design used, there are independent parameters for controlling the impedance matching and isolation: 1) the distance between reflector and Vivaldi radiating elements, 2) the distance between reflector and a combining network ground and the distance between the network ground and the Vivaldi radiating elements, 3) impedance transformers, stubs, and/or discrete components may be used for the impedance matching on the antenna side (or antenna opposite side) of the reflector.

An exemplary embodiment discloses introducing the combining network 403 at the antenna side of the reflector 302, which makes the mechanical integration much easier. The total volume of the antenna decreases. Having the combining network for the radiating pair at the antenna side of the reflector enables a compact combining network 403 for the antenna array 100. The antenna pair radiators and the antenna pair feeding network may be manufactured with simple mechanical parts and/or assemblies. The antenna pair with the feeding network may be manufactured as a single piece. Two polarizations may be integrated to the same space.

An exemplary embodiment enables improving performance. The isolated reflectors enable controlling currents.

An exemplary antenna structure may be implemented with traditional methods and/or advanced methods by using metal parts and cables, by using plated plastics, plated ceramics or plated ceramic hybrids, by using a printed wire board (PWB) structure, by using casting parts, by using machined parts, and/or by using advanced foam structures. An exemplary antenna enables a very cost efficient ultra wideband cellular system, and a corresponding antenna system implementation.

An exemplary embodiment provides a Vivaldi antenna 103 comprising an antenna upper part 101, and an antenna throat (i.e. antenna lower part) 102. The antenna upper part is tilted, in respect to the antenna throat, at a predetermined location of the antenna upper part.

In an exemplary embodiment, the antenna upper part 101 is tilted, in respect to the antenna throat 102, by one or more predetermined tilt angles respectively at one or more predetermined locations of the antenna upper part.

An exemplary embodiment provides a Vivaldi antenna pair 401 comprising two or more of said Vivaldi antennas 103.

In an exemplary embodiment, the antenna element upper part 101 is tilted inwardly and/or outwardly.

In an exemplary embodiment, the antenna pair 401 comprises a combining network (i.e. a feed network) 403 located on an antenna side of a reflector element 302.

In an exemplary embodiment, the antenna pair 401 comprises a combining network 403 located inside or outside a casing (i.e. an “antenna box”) 402 formed by the antennas 103.

In an exemplary embodiment, the antenna pair 401 comprises an impedance matching network implemented in the combining network 403 and located inside or outside the casing formed by the antennas 103.

In an exemplary embodiment, the antenna pair 401 comprises impedance transformers and/or discrete components for impedance matching.

In an exemplary embodiment, the antenna pair 401 comprises a ground plane 111 for impedance matching.

In an exemplary embodiment, the antenna pair 401 comprises one or more ground planes 111 as additional reflector elements inside or outside a casing 402 formed by the antennas 103.

In an exemplary embodiment, the antenna pair 401 comprises a T-junction 121 at a predetermined position of the combining network 403.

In an exemplary embodiment, the antenna pair 401 comprises a modified reflector element for obtaining desired radiation pattern of the antenna pair 401. The modified reflector element may include a shape-modified reflector blade and/or added parts.

In an exemplary embodiment, the antenna pair 401 comprises an increased distance 601 between the reflector element 302 and the antennas 103 for decreasing antenna directivity.

In an exemplary embodiment, the antenna pair 401 comprises an increased distance between the antennas 103 for increasing antenna directivity.

In an exemplary embodiment, the antenna pair 401 comprises a decreased distance between the antennas 103 for decreasing antenna directivity.

In an exemplary embodiment, the antenna pair 401 comprises a decreased distance to reflector for increasing antenna directivity.

An exemplary embodiment provides a Vivaldi antenna array 100 comprising two or more of said antenna pairs 401.

In an exemplary embodiment, polarizations 303 of two or more antenna pairs 401 in the antenna array 100 are combined by using a combining network 403 at an antenna side or antenna opposite side of the reflector element 302.

In an exemplary embodiment, the reflector element 302 comprises a ing polarization ground planes 111, such that isolation between polarizations 303 of the antenna pairs 401 is increased, and a spacing between the common ground plane 141 and the reflector element 302 is increased.

In an exemplary embodiment, the reflector elements 302 in the antenna array 100 are isolated from each other.

An exemplary embodiment provides a base station (e.g. an LTE/LTE-A base station (i.e. an enhanced node-B, eNB)) comprising at least one of said antenna, said antenna pair and said antenna array.

An exemplary embodiment enables controlling the radiation characteristics by providing an antenna, the upper part of which is tilted in a selected way to provide desired radiation characteristics.

By providing an antenna with a modified Vivaldi element height/width, an exemplary embodiment enables obtaining an antenna with modified frequency tuning, radiation characteristics, antenna impedance matching and/or isolation.

An example of a system architecture whereto the embodiments may be applied, is an architecture based on LTE/LTE-A network elements, without restricting the embodiment to such an architecture, however. The embodiments described in these examples are not limited to the LTE/LTE-A radio systems but can also be implemented in other radio systems, such as UMTS (universal mobile telecommunications system), GSM, EDGE, WCDMA, 3G, 4G, 5G, Bluetooth network, WiMAX, WLAN or other fixed, mobile or wireless network. In an embodiment, the presented solution may be applied between elements belonging to different but compatible systems such as LTE and UMTS.

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS

LTE long term evolution

LTE-A long term evolution advanced

UMTS universal mobile telecommunications system

GSM global system for mobile communications

EDGE enhanced data rates for global evolution

WCDMA wideband code division multiple access

3G 3^{rd} generation

4G 4^{th} generation

5G 5^{th} generation

WiMAX worldwide interoperability for microwave access

WLAN wireless local area network

1. A Vivaldi antenna comprising
an antenna upper part, and
an antenna throat,
wherein the antenna upper part is tilted, in respect to the antenna throat, at a predetermined location of the antenna upper part.

2. An antenna according to claim 1, wherein the antenna upper part is tilted, in respect to the antenna throat, by one or more predetermined tilted angles respectively at one or more predetermined locations of the antenna upper part.

3. A Vivaldi antenna pair comprising two or more Vivaldi antennas according to claim 1.

4. An antenna pair according to claim 3, wherein the antenna element upper part is tilted inwardly and/or outwardly.

5. An antenna pair according to claim 3, wherein the antenna pair comprises a combining network located on an antenna side or antenna opposite side of a reflector element.

6. An antenna pair according to claim 3, wherein the antenna pair comprises a combining network located inside or outside a casing formed by the antennas.

7. An antenna pair according to claim 3, wherein the antenna pair comprises an impedance matching network implemented in a combining network and located inside or outside a casing formed by the antennas.

8. An antenna pair according to claim 3, wherein the antenna pair comprises impedance transformers and/or discrete components for impedance matching.

9. An antenna pair according to claim 3, wherein the antenna pair comprises a ground plane for impedance matching.

10. An antenna pair according to claim 3, wherein the antenna pair comprises one or more ground planes as additional reflector elements inside or outside a casing formed by the antennas.

11. An antenna pair according to claim 3, wherein the antenna pair comprises a T-junction at a predetermined position of a combining network.

12. An antenna pair according to claim 3, wherein the antenna pair comprises a modified reflector element for obtaining desired radiation pattern of the antenna pair, wherein the modified reflector element comprises a shape-modified reflector blade and/or added parts.

13. An antenna pair according to claim 3, wherein it comprises an increased distance between a reflector element and the antennas for de-creasing antenna directivity.

14. An antenna pair according to claim 3, wherein it comprises an increased distance between the antennas for increasing antenna directivity.

15. An antenna pair according to claim 3, wherein it comprises a decreased distance to reflector for increasing antenna directivity.

16. A Vivaldi antenna array comprising two or more antenna pairs according to claim 3.

17. An antenna array according to claim 16, wherein polarizations of the antenna pairs are combined by using a combining network at an antenna side of a reflector element.

18. An antenna array according to claim 16, wherein a reflector element comprises a common ground plane on a bottom side of the reflector element for combining polarization ground planes, such that isolation between polarizations of the antenna pairs is increased, and a spacing between the common ground plane and the reflector element is increased.

19. An antenna array according to claim 16, wherein reflector elements are isolated from each other.

20. A base station comprising at least one of an antenna, antenna pair and antenna array according to claim 1.
